(19) United States
(12) Patent Application Publication
(10) Pub. No.: US 2019/0130916 A1
(43) Pub. Date: May 2, 2019

(54) IN-VEHICLE SYSTEM

(71) Applicant: TOYOTA JIDOSHA KABUSHIKI KAISHA, Toyota-shi (JP)

(72) Inventor: Masashi MORI, Nagoya-shi (JP)

(73) Assignee: TOYOTA JIDOSHA KABUSHIKI KAISHA, Toyota-shi (JP)

(21) Appl. No.: 16/170,121

(22) Filed: Oct. 25, 2018

(30) Foreign Application Priority Data
Nov. 1, 2017 (JP) 2017-211598

(51) Int. Cl. G10L 17/00; H04N 13/302; G10L 17/22; H04N 13/398

(52) U.S. Cl. CPC G10L 17/005; H04N 13/398; G10L 17/22; H04N 13/302

(57) ABSTRACT

An in-vehicle system includes: a display section that is configured to stereoscopically display, within a vehicle cabin, a virtual fellow passenger for conversing with a vehicle occupant; a voice detector that detects a voice of the vehicle occupant; a voice recognition section that is configured to recognize the voice detected by the voice detector, and generates conversation information for conversing with the vehicle occupant; a voice generator that generates a voice based on the conversation information; and a controller that is configured to control the display section and the voice generator based on results of voice recognition of the voice recognition section so as to display an image of the virtual fellow passenger operating an onboard device in accordance with instructions of the vehicle occupant, and so as to generate a voice based on the conversation information, and configured to control the onboard device in accordance with the instruction.

### CROSS-REFERENCE TO RELATED APPLICATION

This application is based on and claims priority under 35 USC 119 from Japanese Patent Application No. 2017-211598 filed on Nov. 1, 2017, the disclosure of which is incorporated by reference herein.

### BACKGROUND

### Technical Field

The present disclosure relates to an in-vehicle system that is able to control various types of onboard devices that are installed in a vehicle, and method and storage medium for controlling the in-vehicle system.

### Related Art

Japanese Patent Application Laid-Open (JP-A) No. 2008-210359 discloses an operation device that combines a stereoscopic image of a hand and an operation menu image, which illustrates the placed positions of operation switches at an operation section and the functions of the operation switches, and displays the combined image on a display. The user friendliness may be improved because the operation menu image and the stereoscopic image of a hand are combined and displayed in this way.

However, although a technique related to operation by the driver is proposed in the above document, there is room for further improvement in order to spend a more pleasant time within the vehicle cabin.

### SUMMARY

The present disclosure has been made in view of the above-described circumstances, and provides an in-vehicle system that provides a vehicle occupant with improved experiences within the vehicle cabin with the feeling that an ordinary fellow passenger is present, and method and storage medium for controlling the in-vehicle system.

A first aspect of the present disclosure is an in-vehicle system including: a display section that is configured to stereoscopically display, within a vehicle cabin, a virtual fellow passenger for conversing with a vehicle occupant; a voice detector that detects a voice of the vehicle occupant; a voice recognition section that is configured to recognize the voice detected by the voice detector, and generates conversation information for conversing with the vehicle occupant; a voice generator that generates a voice based on the conversation information; and a controller that is configured to control the display section and the voice generator based on results of voice recognition of the voice recognition section so as to display an image of the virtual fellow passenger operating an onboard device in accordance with instructions of the vehicle occupant, and so as to generate a voice based on the conversation information, and configured to control the onboard device in accordance with the instruction.

In accordance with the first aspect a virtual fellow passenger that may converse with a vehicle occupant is stereoscopically displayed by the display section within the vehicle cabin. Namely, the vehicle occupant may be provided with the feeling that an ordinary fellow passenger is present due to the virtual fellow passenger being stereoscopically displayed.

Further, the voice of the vehicle occupant is detected at the voice detector, the detected voice is recognized at the voice recognition section, and conversation information for conversing with the vehicle occupant is generated. Then, a voice that is based on the generated conversation information is generated at the voice generator. As a result, a conversation may be carried out with the virtual fellow passenger.

On the basis of the results of recognition by the voice recognition section, the display section and the voice generator are controlled by the controller so as to display an image of the virtual fellow passenger operating an onboard device in accordance with instructions of the vehicle occupant, and so as to generate a voice that is based on the conversation information, and the onboard device is controlled in accordance with the instruction. As a result, the vehicle occupant is able to spend a pleasant time within the vehicle cabin with the feeling that an ordinary fellow passenger is present due to conversations of the vehicle occupant with the virtual fellow passenger that is displayed stereoscopically, or due to operation of the onboard device by the virtual fellow passenger.

A second aspect of the present disclosure is an in-vehicle system including: a display section that is configured to stereoscopically display, within a vehicle cabin, a virtual fellow passenger for conversing with a vehicle occupant; a voice detector that detects a voice of the vehicle occupant; a voice recognition section that is configured to recognize the voice detected by the voice detector, and generates conversation information for conversing with the vehicle occupant; a voice generator that generates a voice based on the conversation information; a storage section that is configured to store preference information relating to preferences of the vehicle occupant; a preference analyzing section that is configured to perform analysis of preferences of the vehicle occupant based on the preference information stored in the storage section; and a controller that is configured to control the display section and the voice generator so as to display an image of the virtual fellow passenger making a proposal based on results of analysis of the preference analyzing section, and so as to generate a voice based on the conversation information that corresponds to the results of analysis.

In accordance with the second aspect, a virtual fellow passenger that may converse with a vehicle occupant is stereoscopically displayed by the display section within the vehicle cabin. Namely, the vehicle occupant may be provided with the feeling that an ordinary fellow passenger is present due to the virtual fellow passenger being stereoscopically displayed.

Further, the voice of the vehicle occupant is detected at the voice detector, the detected voice is recognized at the voice recognition section, and conversation information for conversing with the vehicle occupant is generated. Further, a voice based on the generated conversation information is generated at the voice generator. As a result, the vehicle occupant may converse with the virtual fellow passenger.

Preference information relating to the preferences of the vehicle occupant is stored at the storage section. Analysis of the preferences of the vehicle occupant is carried out by the preference analyzing section, on the basis of the preference information stored in the storage section. For example, the preference information may include information on nearby establishments that have been visited, past history of operation of the onboard devices indicating the preferences of the vehicle occupant such as the vehicle cabin temperature, selection and volume of music, and the like, and the states of the vehicle and the vehicle occupant, and the like. This preference information is learned as instructional information of learning by artificial intelligence of a neural network or the like, and the states of the tastes of the vehicle occupant are analyzed.

Then the controller controls the display section and the voice generator so as to display an image of the virtual fellow passenger making a proposal based on the results of analysis of the preference analyzing section, and so as to generate a voice based on the conversation information that corresponds to the results of the analysis. As a result, a vehicle occupant is able to spend a pleasant time within the vehicle cabin with the feeling that an ordinary fellow passenger is present due to the vehicle occupant conversing with the virtual fellow passenger that is displayed stereoscopically, or by proposals from the virtual fellow passenger that are based on the results of the preference analysis.

The in-vehicle system of the above-described aspects may further include a burden detecting section that is configured to detect a driving burden of a driver, wherein the controller is configured to control the display section such that, in a case in which it is detected by the burden detecting section that there is no driving burden, the virtual fellow passenger is displayed, and, in a case in which it is detected by the burden detecting section that there is the driving burden, the virtual fellow passenger is not displayed.

A driver (vehicle occupant) may thus communicate with the virtual fellow passenger while ensuring the safety of the driver.

As described above, in accordance with the present disclosure, there may be provided an in-vehicle system that provides a vehicle occupant with improved experiences within a vehicle cabin with the feeling that an ordinary fellow passenger is present.

### BRIEF DESCRIPTION OF THE DRAWINGS

FIG. 1 is a schematic view illustrating an overview of an in-vehicle system according to an embodiment.

FIG. 2 is a block diagram illustrating the structure of the in-vehicle system according to the embodiment.

FIG. 3 is a schematic view illustrating the structure of an example of a 3D stereoscopic display device.

FIG. 4 is a flowchart illustrating an example of the processing flow that is carried out at an onboard unit of the in-vehicle system according to the embodiment.

FIG. 5 is a flowchart illustrating an example of the processing flow that is carried out at a voice recognition center of the in-vehicle system according to the embodiment.

FIG. 6 is a flowchart illustrating an example of the processing flow that is carried out at an information database (DB) center of the in-vehicle system according to the embodiment.

FIG. 7 is a flowchart illustrating an example of the processing flow that is carried out at a preference analysis controller of the information DB center in a case in which a conversation is started by a virtual fellow passenger, in the in-vehicle system according to the embodiment.

FIG. 8 is a flowchart illustrating an example of the processing flow that is carried out at a conversation controller of the voice recognition center in a case in which a conversation is started by the virtual fellow passenger, in the in-vehicle system according to the embodiment.

FIG. 9 is a flowchart illustrating an example of the processing flow that is carried out at a control ECU of the onboard unit in a case in which a conversation is started by the virtual fellow passenger, in the in-vehicle system according to the embodiment.

FIG. 10 is a block diagram illustrating the structure of an in-vehicle system that is configured such that the information DB center is installed in the onboard unit.

### DETAILED DESCRIPTION

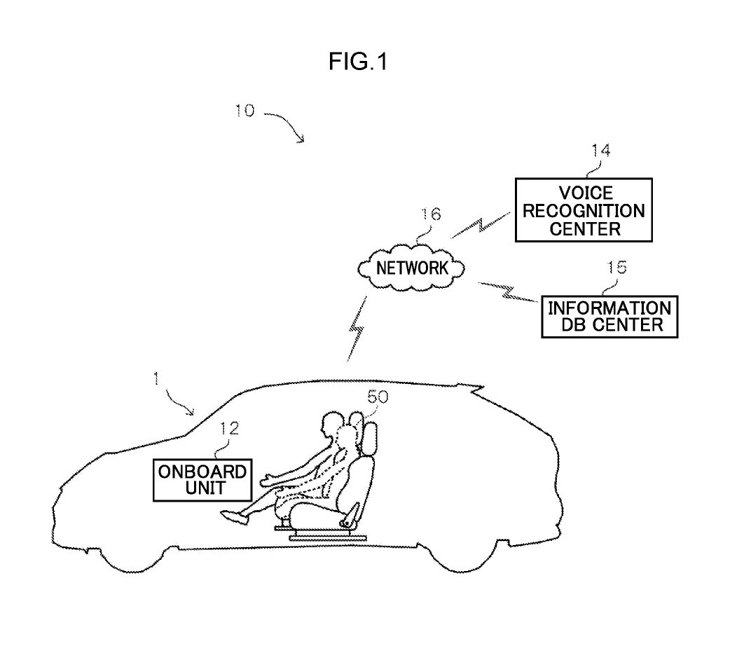

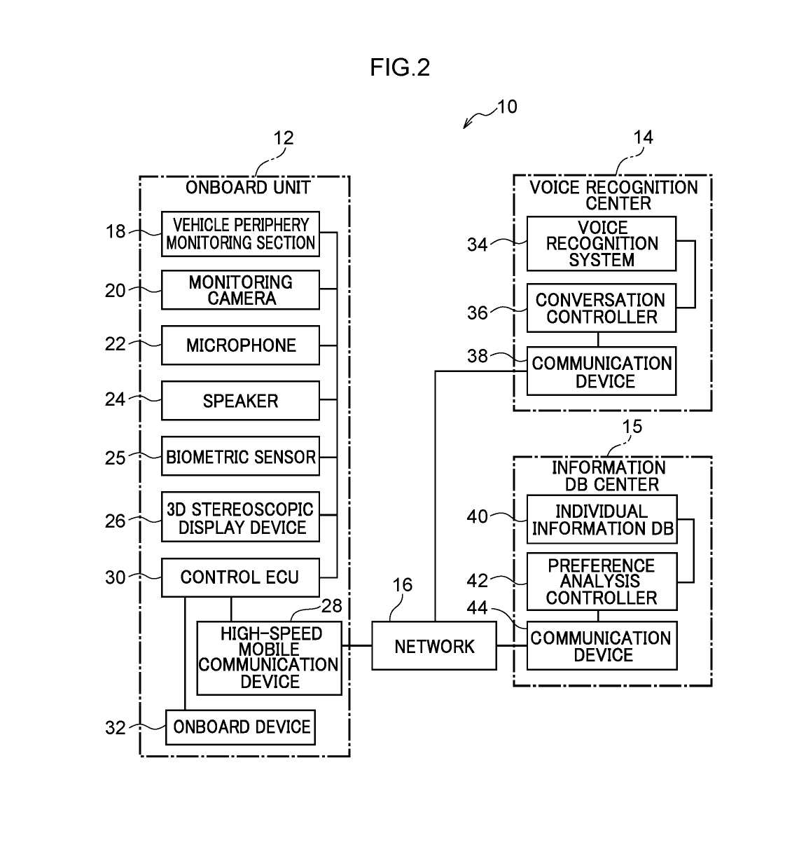

An embodiment of the disclosure is described in detail hereinafter with reference to the drawings. FIG. 1 is a schematic view illustrating the structure of an in-vehicle system according to an embodiment. FIG. 2 is a block drawing illustrating the structure of the in-vehicle system according to the embodiment.

An in-vehicle system 10 according to the embodiment includes an onboard unit 12 that is installed in a vehicle 1, a network 16, a voice recognition center 14 that serves as a voice recognition section, and an information database (DB) center 15 that serves as a preference analyzing section. In the in-vehicle system 10, the onboard unit 12 displays a virtual fellow passenger 50, the voice recognition center 14 recognizes a conversation between a vehicle occupant and the virtual fellow passenger 50, and the information DB center 15 carries out preference analysis. Then, the onboard unit 12 controls the display of the virtual fellow passenger 50 based on the results of the voice recognition and the results of the preference analysis, and presents information suited to the preferences of the vehicle occupant, or operates onboard devices in accordance with instructions of the vehicle occupant.

Specifically, in the in-vehicle system 10 according to the embodiment, the onboard unit 12, the voice recognition center 14 and the information DB center 15 are respectively connected via the network 16 that includes a mobile phone line or the like.

The onboard unit 12 is installed in the vehicle 1, and is capable of communicating with the voice recognition center 14 and the information DB center 15 that are connected to the network 16.

The onboard unit 12 includes a vehicle periphery monitoring section 18, a monitoring camera 20, a microphone 22 that serves as a voice detector, a speaker 24 that serves as a voice generator, a biometric sensor 25, a three-dimensional (3D) stereoscopic display device 26 that serves as a display section, a high-speed mobile communication device 28, and onboard devices 32. These components are respectively connected to a control Electronic Control Unit (ECU) 30 that serves as a controller and a burden detecting section.

The vehicle periphery monitoring section 18 monitors the situation at the periphery of the vehicle in order to detect whether or not there is a state in which the in-vehicle system 10 is able to be used safely. Specifically, the vehicle periphery monitoring section 18 includes at least one of a camera, radar, or Laser Imaging Detection and Ranging (LIDER) system. The camera is, for example, provided within the vehicle cabin at an upper portion of the front windshield of the vehicle 1, and acquires image information by imaging the exterior of the vehicle 1. The camera may be a monocular camera, or may be a stereo camera. In the case of a stereo camera, the camera includes two imaging sections that are disposed to as to reproduce binocular parallax. Information relating to the depth direction also is included in the image information of the stereo camera. The radar transmits electric waves (e.g., millimeter waves) to the periphery of the vehicle 1, and detects obstacles by receiving electric waves that have been reflected by the obstacles. LIDER transmits light to the periphery of the vehicle 1, receives light that has been reflected by obstacles, and measures the distances to the reflection points to detect the obstacles. Note that the vehicle periphery monitoring section 18 does not have to include all of a camera, LIDER and radar.

The monitoring camera 20 is provided within the vehicle cabin, captures images of the driver and passengers within the vehicle cabin, and outputs the captured images to the control ECU 30 as image information.

The microphone 22 is provided within the vehicle cabin, converts voices within the vehicle cabin, such as the voice of a vehicle occupant, into electric signals, and outputs the electric signals to the control ECU 30 as voice information.

The speaker 24 is provided within the vehicle cabin, and converts the voice information and the like, that have been transmitted from the control ECU 30, into physical vibrations, and generates sounds such as voices.

The biometric sensor 25 detects biometric information such as pulse, blood pressure, heart rate or the like, in order to detect the state of a vehicle occupant.

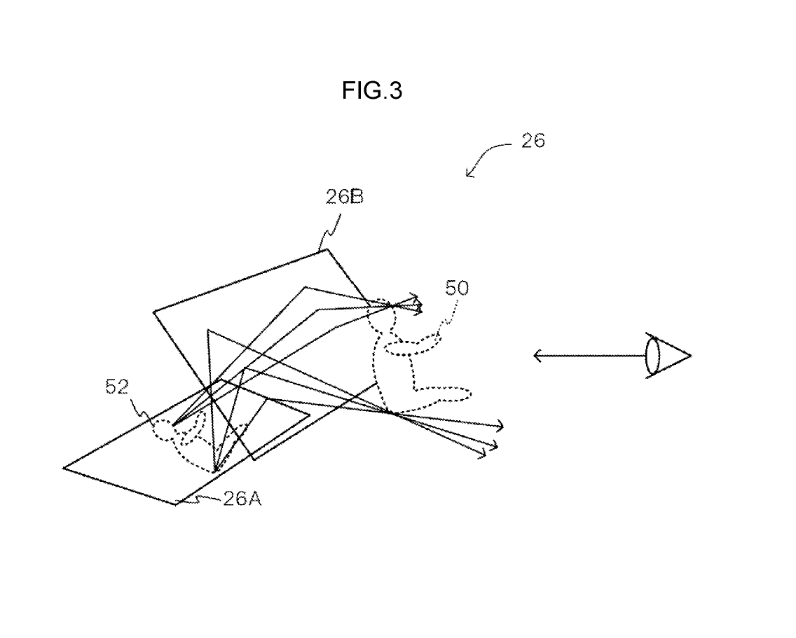

The 3D stereoscopic display device 26 displays, as a three-dimensional stereoscopic image and within the vehicle cabin, the virtual fellow passenger 50 that may converse with a vehicle occupant. Specifically, the stereoscopic image may be displayed by using the technique disclosed in Japanese Patent No. 5646110, or the aerial imaging (AI) plate (http://aerialimaging.tv/) manufactured by Asukanet Co., Ltd. In this case, as illustrated in FIG. 3, the 3D stereoscopic display device 26 may include an AI plate 26B, and a stereoscopic image reproducing device 26A that displays a stereoscopic image 52 that emits light in a static state or a dynamic state based on electronic data. The 3D stereoscopic display device 26 forms the stereoscopic image 52 as the stereoscopic virtual fellow passenger 50 within a free space at the front surface side of the AI plate 26B. Such a device may be provided beneath the seat cushion of a vehicle seat, and the virtual fellow passenger may be displayed on the vehicle seat by removing the seat cushion. Alternatively, two projectors and a screen may be provided within the vehicle cabin, and an image of the virtual fellow passenger 50 may be displayed on the screen. Note that the character of the virtual fellow passenger 50 may be changed in accordance with the preferences of the vehicle occupant.

The high speed mobile communication device 28 is connected to the network 16, which is a mobile phone line network or a public line network, and carries out transmission and reception of information with the voice recognition center 14 and the information DB center 15 that are connected to the network 16. For example, the high speed mobile communication device 28 transmits via the network 16 to the voice recognition center 14 and the information DB center 15, captured image information captured by the monitoring camera 20 and voice information acquired by the microphone 22. Further, the high speed mobile communication device 28 receives information from the voice recognition center 14 and the information DB center 15 via the network 16.

The onboard devices 32 are apparatuses that are installed in the vehicle 1, and include various types of onboard devices such as, for example, the air conditioner, an audio device, and the like.

The control ECU 30 performs various types of control for communication between the vehicle occupant and the virtual fellow passenger 50, and for presenting information and controlling the onboard devices 32 in accordance to the preferences of the vehicle occupant, by communicating with the voice recognition center 14 and the information DB center 15 that are connected to the network 16. When carrying out presentation of information or control of the onboard devices 32, the control ECU 30 controls display of a stereoscopic image and generation of a voice such that the virtual fellow passenger 50 appears to carry out the presentation of information to the vehicle occupant, or operation of the onboard devices 32.

The voice recognition center 14 includes a voice recognition system 34, a conversation controller 36, and a communication device 38. The voice recognition center 14 is realized by a computer that includes a CPU, a ROM, a RAM and the like.

The voice recognition system 34 analyzes voice information (data) received from the onboard unit 12, and carries out voice recognition of the vehicle occupant using known voice recognition techniques.

The conversation controller 36 devises communication between the vehicle occupant and the virtual fellow passenger 50 by generating conversation information (data) based on the results of voice recognition by the voice recognition system 34 and returning the conversation information to the onboard unit 12. At the time of generating the conversation information based on the results of voice recognition, the conversation controller 36 generates the conversation information using the results of the preference analysis obtained from the information DB center 15.

Any of various known techniques may be used for the voice recognition and for the generating of the conversation information by the conversation controller 36 and, therefore, detailed description thereof is omitted.

The communication device 38 is connected to the network 16 which is a mobile phone line network or a public line network, and is capable of communicating with the onboard unit 12 and the information DB center 15 that are connected to the network 16.

The information DB center 15 includes an individual information DB 40 that serves as a storage section, a preference analysis controller 42, and a communication device 44. Similarly to the voice recognition center 14, the information DB center 15 is realized by a computer including a CPU, a ROM, a RAM and the like.

The individual information DB 40 stores various types of information relating to the vehicle occupant as individual information (data). For example, information such as network payment settlement history, credit card usage information, position information linked to a smartphone that the vehicle occupant carries, information of topics collected from networks such as the internet and the like are stored in the individual information DB 40. Specifically, the preference analysis controller 42 collects, from the onboard unit 12 and the mobile phone of the vehicle occupant or the like, information such as categories, positions and the like of restaurants which the vehicle occupant went by the vehicle, and stores these information in the individual information DB 40.

The preference analysis controller 42 performs preference analysis of the vehicle occupant based on captured image information and the state of the vehicle occupant (the results of detection of the biometric sensor 25 and the like) obtained from the onboard unit 12, and the conversation information and the results of voice recognition performed by the voice recognition center 14, selects information that suits the preferences of the vehicle occupant, and returns the information to the voice recognition center 14. Further, the preference analysis controller 42 learns, by artificial intelligence using a neural network or the like, various types of information such as the temperature setting of the air conditioner, the volume setting of the audio system, and the like, as well as timing for proposing such information, and presents the various types of information to the vehicle occupant. Note that the preference analysis by the preference analysis controller 42 may be performed by using artificial intelligence (AI) techniques.

The communication device 44 is connected to the network 16, which is a mobile phone line network or a public line network, and is capable of communicating with the onboard unit 12 and the voice recognition center 14 that are connected to the network 16.

Next, an example of communication with the virtual fellow passenger 50 in the in-vehicle system 10 according to the embodiment as configured above will be described.

For example, in a case in which the vehicle occupant starts talking to the virtual fellow passenger 50 such as “What shall we have for lunch?”, the voice recognition center 14 recognizes the voice of the vehicle occupant, and the information DB center 15 searches for information relating to establishments corresponding to an individual indicated by the results of recognition, based on the result of preference analysis. The preference analysis may be carried out by using various known techniques as the method of preference analysis. For example, current location information is obtained from a navigation device, which is the onboard device 32, or from the mobile phone of the vehicle occupant, establishments in the vicinity of the current location are searched for, preference analysis is carried out from the number of visits per category of the establishments visited in the past, and establishments to be recommended are retrieved. Then, the information DB center 15 returns the results of searching to the voice recognition center 14, the voice recognition center 14 generates conversation information for proposing the recommended establishments and returns the information to the onboard unit 12, and the virtual fellow passenger 50 proposes the recommended establishments to the vehicle occupant based on the conversation information. For example, the onboard unit 12 controls the speaker 24 and emits a message such as “X looks like a popular place”. If, in response thereto, the vehicle occupant says “Okay, let's try it out”, the onboard unit 12 transmits the voice information of the vehicle occupant to the voice recognition center 14, the voice recognition center 14 carries out voice analysis and generates response information. For example, positional information of the establishment to be visited is transmitted as the response information at this time. Then, in a case in which the response information is returned to the onboard unit 12, the control ECU 30 of the onboard unit 12 controls the navigation device as the onboard device 32, and causes the navigation device to set the destination. When this is performed, an image is displayed such that the virtual fellow passenger 50 is carrying out setting of the destination on the navigation device.

Further, in the in-vehicle system 10 according to the embodiment, the driving burden of the driver is detected, and the virtual fellow passenger 50 is displayed when there is no driving burden such as during automatic driving. Specifically, the control ECU 30 detects, as the driving burden, whether there is a state in which the in-vehicle system 10 may be used safely, based on the results of monitoring the periphery of the vehicle by the vehicle periphery monitoring section 18. The control ECU 30 judges that there is a state in which the in-vehicle system 10 may be used safely when there is no driving burden on the driver such as, in a case in which the control ECU has switched the driving mode to an automatic driving mode based on the results of monitoring of the vehicle periphery monitoring section 18, and the vehicle 1 enters into the automatic driving mode. Then, the onboard unit 12 displays the virtual fellow passenger 50. Note that the judgment on whether or not switching the driving mode to the automatic driving mode may be carried out using known automatic driving technology based on the results of monitoring of the vehicle periphery monitoring section 18.

Further, even in the midst of communication, if a state in which the in-vehicle system 10 may not be used safely is detected from the results of monitoring of the vehicle periphery monitoring section 18, the control ECU 30 terminates the displaying of the virtual fellow passenger 50. The driver may thereby communicate with the virtual fellow passenger 50 while ensuring safety.

Next, specific processing performed at the respective sections of the in-vehicle system 10 according to the embodiment are described below.

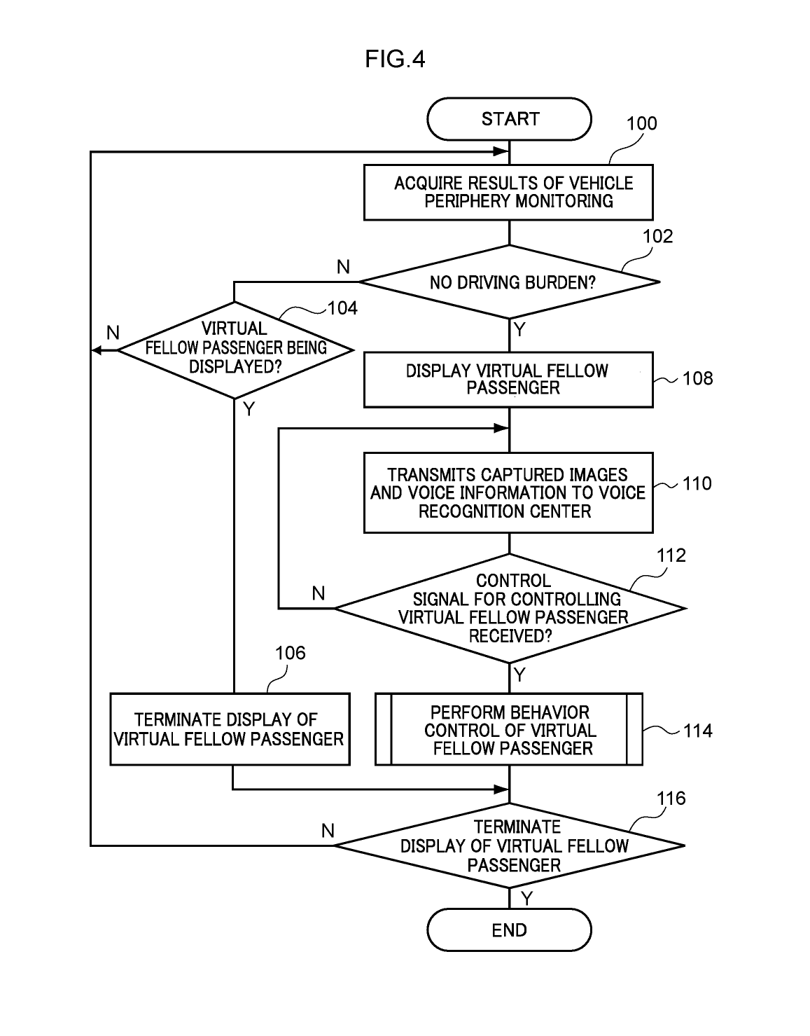

First, processing performed at the onboard unit 12 are described. FIG. 4 is a flowchart illustrating the processing flow that is performed at the onboard unit 12 of the in-vehicle system 10 according to the embodiment. Note that the processing of FIG. 4 starts, for example, when an instruction to start-up the vehicle 1 via an ignition switch or the like is given in a state in which displaying of the virtual fellow passenger 50 has been set to the vehicle 1 in advance.

In step 100, the control ECU 30 acquires the results of monitoring the vehicle periphery by the vehicle periphery monitoring section 18, and the processing proceeds to step 102.

In step 102, the control ECU 30 judges whether or not there is no driving burden on the driver. For example, the control ECU 30 determines whether or not the vehicle 1 is in the automatic driving mode, judges that there is a state in which the in-vehicle system 10 may be used safely if there is no driving burden on the driver. The judgment as to whether or not the vehicle 1 is in the automatic driving mode may be carried out based on the results of monitoring the periphery of the vehicle, for example. If this judgment is negative, the processing proceeds to step 104. Otherwise, i.e., if this judgment is affirmative, the processing proceeds to step 108.

In step 104, the control ECU 30 judges whether or not step 114, which will be described later, has already been carried out and the virtual fellow passenger 50 is being displayed. If this judgment is affirmative, the processing proceeds to step 106. If this judgment is negative, the processing returns to step 100, and the above-described processing is repeated.

In step 106, the control ECU 30 terminates the display of the virtual fellow passenger 50, and the processing proceeds to step 116. Namely, in the embodiment, the virtual fellow passenger 50 is displayed only in a case in which there is no driving burden, and is not displayed in a case in which there is a driving burden. The vehicle occupant may thereby communicate with the virtual fellow passenger 50 while ensuring safety.

In step 108, the control ECU 30 controls the 3D stereoscopic display device 26 to display the virtual fellow passenger 50, and the processing proceeds to step 110.

In step 110, the control ECU 30 transmits captured images captured by the monitoring camera 20 and voice information collected by the microphone 22 to the voice recognition center 14, and the processing proceeds to step 112.

In step 112, the control ECU 30 judges whether or not a control signal for controlling the virtual fellow passenger 50 has been received from the voice recognition center 14. If this judgment is negative, the processing returns to step 110 and the above-described processing is repeated. If this judgment is affirmative, the processing proceeds to step 114.

In step 114, the control ECU 30 carries out behavior control of the virtual fellow passenger 50, and the processing proceeds to step 116. In the behavior control of the virtual fellow passenger 50, for example, in a case in which operation of the air conditioner or the audio device is instructed by conversation with the vehicle occupant, the control ECU 30 controls the 3D stereoscopic display device 26 and the speaker 24 so as to display an image of the virtual fellow passenger 50 operating the onboard device 32 that corresponds to the instruction of the vehicle occupant, and so as to generate a voice based on conversation information. As will be described later, the conversation information is generated by the voice recognition center 14 in accordance with the results of preference analysis of the information DB center 15.

In step 116, the control ECU 50 judges whether or not to terminate display of the virtual fellow passenger 50. For example, the judgment may include judging whether or not termination of the display of the virtual fellow passenger 50 has been instructed by voice of the vehicle occupant, or judging whether or not a switch that instructs termination of the display of the virtual fellow passenger 50 has been operated. If this judgment is negative, the processing returns to step 100, and the above-described processing is repeated. If this judgment is affirmative, the processing ends.

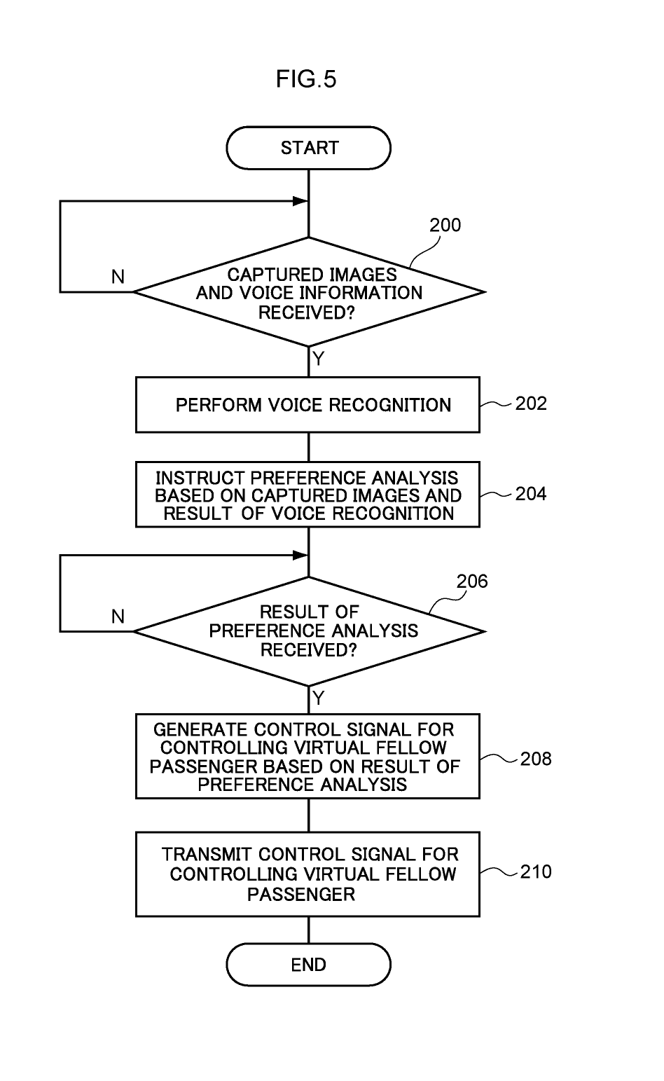

Next, specific processing carried out by the voice recognition center 14 are described. FIG. 5 is a flowchart illustrating the processing flow that is performed at the voice recognition center 14 of the in-vehicle system 10 according to the embodiment. In the embodiment, the processing of FIG. 5 starts in a case in which voice information and captured image information of the vehicle occupant have been transmitted from the onboard unit 12 in step 110.

In step 200, the conversation controller 36 judges whether or not captured images and voice information transmitted from the onboard unit 12 have been received. The routine waits until this judgment become affirmative, and then proceeds to step 202.

In step 202, the voice recognition system 34 carries out voice recognition on the voice information received from the onboard unit 12, and the processing proceeds to step 204.

In step 204, the conversation controller 36 instructs the information DB center 15 to carry out preference analysis based on the captured images received from the onboard unit 12 and the results of voice recognition by the voice recognition system 34, and the processing proceeds to step 206.

In step 206, the conversation controller 36 judges whether or not results of preference analysis have been received from the information DB center 15. The routine waits until this judgment is affirmative, and then proceeds to step 208.

In step 208, the conversation controller 36 generates a control signal for the virtual fellow passenger 50 based on the results of the preference analysis, and the processing proceeds to step 210. Specifically, in accordance with the results of the preference analysis, the conversation controller 36 generates a control signal including conversation information expressing a message such as “X looks like a popular place.” or the like.

In step 210, the conversation controller 36 returns to the onboard unit 12 the generated control signal for the virtual fellow passenger 50, and the processing ends.

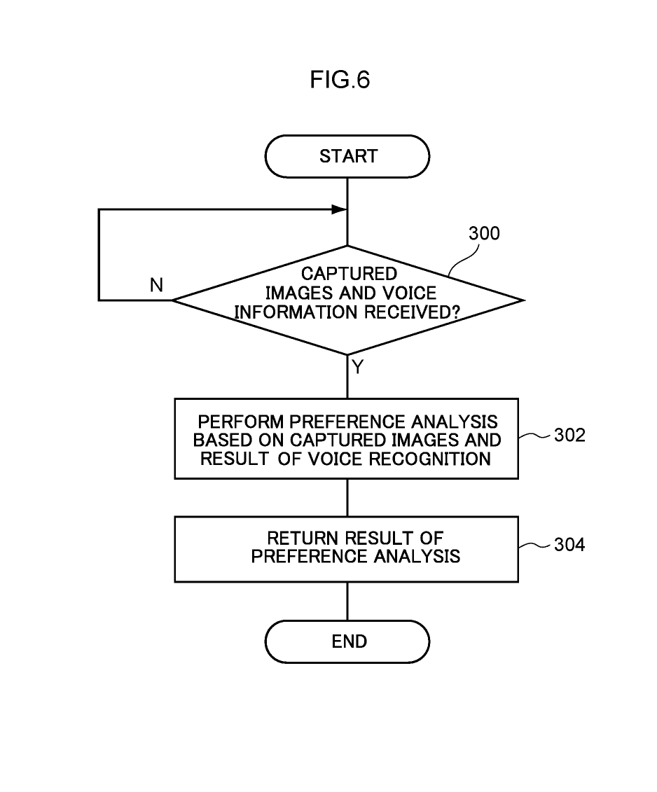

Specific processing carried out at the information DB center 15 is described next. FIG. 6 is a flowchart illustrating an example of the processing flow carried out at the preference analysis controller 42 of the information DB center 15 of the in-vehicle system 10 according to the embodiment.

In step 300, the preference analysis controller 42 judges whether or not image information and the results of voice recognition have been received from the voice recognition center 14. The routine waits until this judgment is affirmative, and then proceeds to step 302.

In step 302, the preference analysis controller 42 carries out preference analysis based on the captured images and the results of voice recognition, and the processing proceeds to step 304. Namely, the preference analysis controller 42 carries out preference analysis by using the individual information of the vehicle occupant stored in the individual information DB 40 of the information DB center 15. For example, the preference analysis controller 42 carries out preference analysis based on the expression and conversation of the vehicle occupant and on the information stored in the individual information DB 40, and retrieves information to be proposed such as establishments that the vehicle occupant prefers. Note that the state of the vehicle occupant such as the expression of the vehicle occupant and the like may be obtained by image processing on the captured images at the control ECU 30 of the onboard unit 12, and only an ID code expressing the state of the vehicle occupant may be transmitted to the information DB center 15.

In step 304, the preference analysis controller 42 returns the results of preference analysis to the voice recognition center 14, and the processing ends.

Due to the processing being carried out by the respective sections in this way at the in-vehicle system 10 according to the embodiment, because the virtual fellow passenger 50 is displayed, the conversation partner becomes clear, and a vehicle occupant may communicate with the virtual fellow passenger 50 without an uncomfortable feeling. Further, the in-vehicle system 10 allows a vehicle occupant to instruct the virtual fellow passenger 50 to operate the onboard device 32, and cause the virtual fellow passenger 50 to operate the onboard device 32, thereby enables a vehicle occupant to enjoy the driving with the feeling such that there is an ordinary fellow passenger present.

In the above embodiment, the processing has been described of a case in which conversation is started from the vehicle occupant to the virtual fellow passenger 50. However, starting of a conversation is not limited to being from the vehicle occupant, and conversation may be started from the virtual fellow passenger 50. The following describes an example of a case in which conversation starts from the virtual fellow passenger 50.

For example, the preference analysis controller 42 collects information relating to the vehicle and the vehicle occupant from the onboard unit 12 and carries out preference analysis. In the preference analysis here, for example, the preferences of the vehicle occupant such as the vehicle cabin temperature, selection and volume of music, and the like, are learned as instructional information of learning by artificial intelligence of a neural network or the like from past history of operation of the onboard devices 32 and the states of the vehicle and the vehicle occupant, and the preferred states of the vehicle occupant are analyzed. Then, based on the information collected from the onboard unit 12, in a case in which the current state of the vehicle occupant deviates from the vehicle occupant's preferred state, the preferred state is transmitted from the voice recognition center 14 to the onboard unit 12 as information to be presented (i.e., presentation information). The onboard unit 12 thereby controls the behavior of the virtual fellow passenger 50, and carries out operation of the corresponding onboard device 32.

As another example, the preference analysis controller 42 acquires information from the navigation device, and, in the case of an occurrence of a traffic jam, predicts the arrival time and judges whether or not it would be better to stop-in at a nearby establishment. Then, in a case in which it would be better to stop-in at a nearby establishment, the preference analysis controller 42 may carry out preference analysis of the vehicle occupant based on information relating to nearby establishments and the information stored in the individual information DB 40, and generate information to be presented that proposes an establishment that suits the preference of the vehicle occupant, and propose that the vehicle occupant avoid the traffic jam by transmitting this information to the onboard unit 12 via the voice recognition center 14.

Here, a specific example of processing carried out at the in-vehicle system 10 in a case in which conversation is started from the virtual fellow passenger 50 is described.

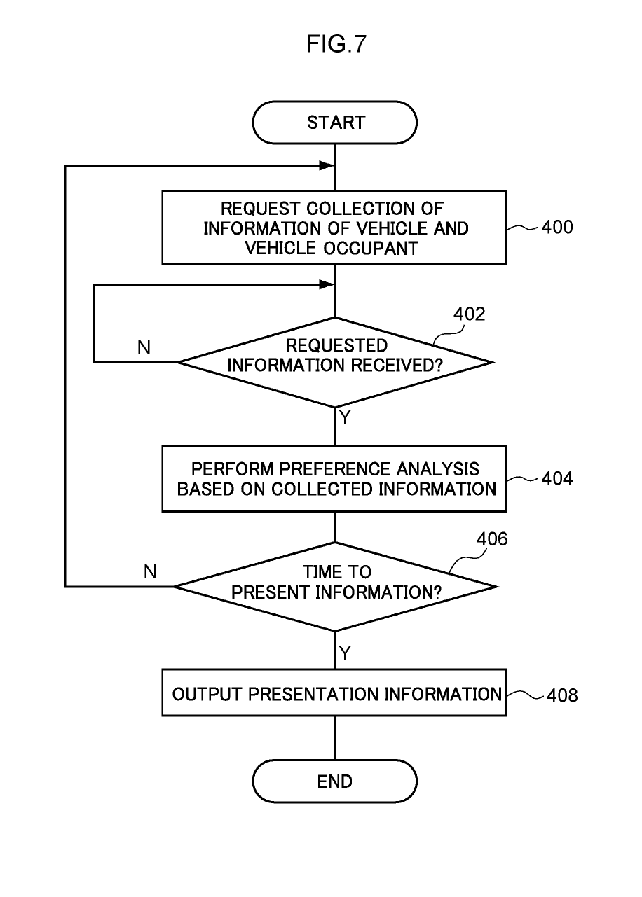

FIG. 7 is a flowchart illustrating an example of processing carried out at the preference analysis controller 42 of the information DB center 15 in a case in which conversation is started from the virtual fellow passenger. Note that the processing of FIG. 7 is performed, for example, every predetermined time period. Alternatively, the processing of FIG. 7 may be started after the vehicle 1 has been started-up and when communication becomes possible, and may be repeated from the start after it ends.

In step 400, the preference analysis controller 42 issues, to the onboard unit 12, a request to collect information relating to the vehicle and the vehicle occupant, and the processing proceeds to step 402. For example, a request is transmitted to the onboard unit 12 to collect information relating to the vehicle 1 such as positional information acquired from a navigation device that serves as the onboard device 32, the vehicle speed, the air conditioning temperature, the volume of music and the like, and information relating to the vehicle occupant such as the results of detection of the biometric sensor 25 or image information of the vehicle occupant captured by the monitoring camera 20.

In step 402, the preference analysis controller 42 judges whether or not the requested information has been received. The routine waits until this judgment is affirmative, and then proceeds to step 404.

In step 404, the preference analysis controller 42 carries out preference analysis based on the collected information, and the processing proceeds to step 406. For example, preferences of the vehicle occupant such as establishments that are near the current location, the vehicle cabin temperature, the sound volume, and the like are analyzed.

In step 406, the preference analysis controller 42 judges whether or not it is a time to present information. In this judgment, for example, it is judged whether or not it is a time to present information that has been learned by artificial intelligence or the like from information relating to the vehicle and the vehicle occupant, or the like. If this judgment is negative, the processing returns to step 400, and the above-described processing is repeated. If this judgment is affirmative, the processing proceeds to step 408.

In step 408, the preference analysis controller 42 outputs information to be proposed, that has been obtained by the preference analysis, to the voice recognition center 14 as information to be presented, and the processing ends.

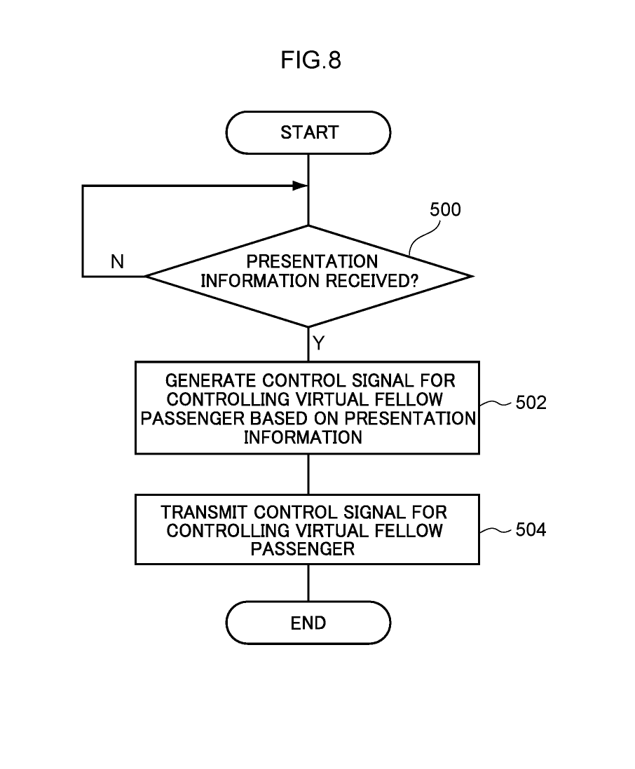

FIG. 8 is a flowchart illustrating an example of the processing flow carried out at the conversation controller 36 of the voice recognition center 14 in a case in which conversation is started from the virtual fellow passenger in the in-vehicle system 10 according to the embodiment. Note that the processing of FIG. 8 starts, for example, when information to be presented has been transmitted from the information DB center 15 to the conversation controller 36.

In step 500, the conversation controller 36 judges whether or not information to be presented has been received from the information DB center 15. The routine waits until this judgment is affirmative, and then proceeds to step 502.

In step 502, the conversation controller 36 generates a control signal for the virtual fellow passenger 50 based on the information to be presented, and the processing proceeds to step 504. Specifically, the conversation controller 36 generates a control signal that includes conversation information corresponding to the information to be presented. For example, conversation information for proposing a nearby establishment that suits the tastes of the vehicle occupant, conversation information for proposing a change in the vehicle cabin temperature, conversation information for proposing a change in the sound volume, conversation information for proposing avoiding of a traffic jam, or the like is generated as the control signal for the virtual fellow passenger 50.

In step 504, the conversation controller 36 transmits the control signal for the virtual fellow passenger 50 to the onboard unit 12, and the processing ends.

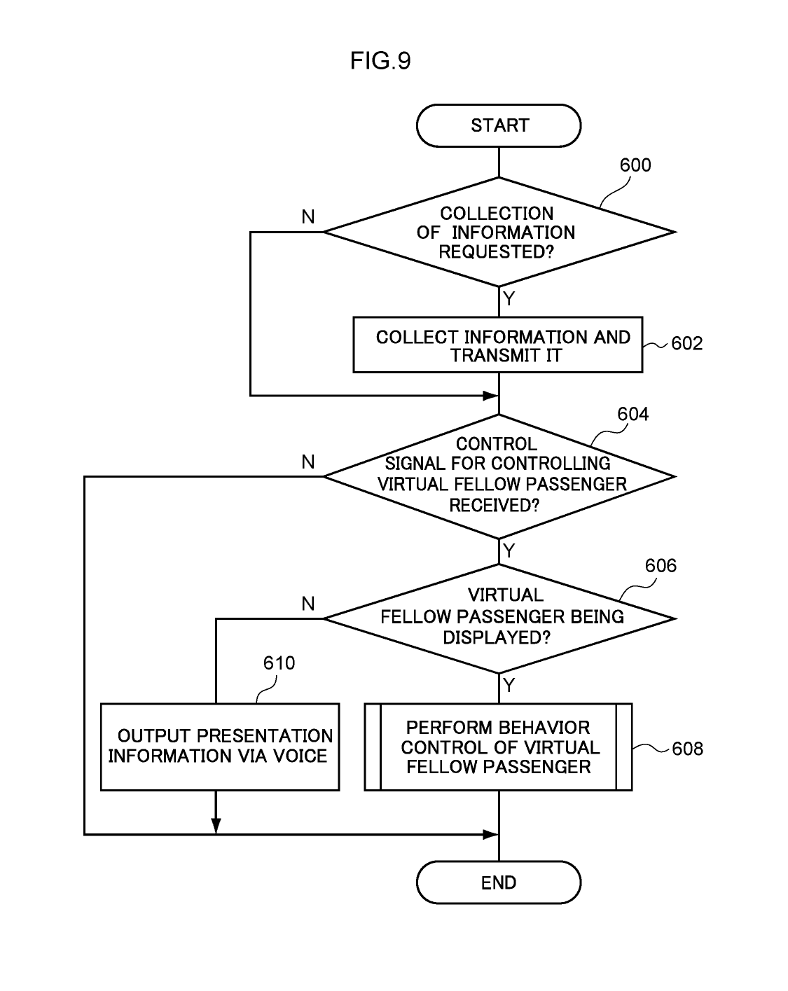

FIG. 9 is a flowchart illustrating an example of the processing carried out at the control ECU 30 of the onboard unit 12 in a case in which conversation is started from the virtual fellow passenger in the in-vehicle system 10 according to the embodiment. Note that the processing of FIG. 9 is started, for example, when a request to collect information is made from the information DB center 15, or when the control signal for the virtual fellow passenger 50 has been transmitted from the voice recognition center 14 to the onboard unit 12.

In step 600, the control ECU 30 judges whether or not a request to collect information has been made from the information DB center 15. In this judgment, it is judged whether or not an information collection request has been made by above-described step 400. If this judgment is affirmative, the processing proceeds to step 602. If this judgment is negative, the processing proceeds to step 604.

In step 602, the control ECU 30 collects information, and transmits the collected information to the information DB center 15, and the processing proceeds to step 604. For example, the control ECU 30 collects various types of information such as images of the vehicle occupant captured by the monitoring camera 20, voice of the vehicle occupant collected by the microphone 22, results of detection of the biometric sensor 25, information obtained from the onboard devices 32 (e.g., position information, vehicle cabin temperature, sound volume, and the like), and transmits these information to the information DB center 15.

In step 604, the control ECU 30 judges whether or not a control signal for the virtual fellow passenger 50 has been received. In this judgment, it is judged whether or not the control signal transmitted from the voice recognition center 14 by above-described step 504 has been received. If this judgment is affirmative, the processing proceeds to step 606. If this judgment is negative, the processing is ended, and other processing is carried out.

In step 606, the control ECU 30 judges whether or not the virtual fellow passenger 50 is being displayed. In this judgment, for example, it is judged whether or not above-described step 114 has already been executed and the virtual fellow passenger 50 is being displayed. Alternatively, similarly to step 102, it is judged whether or not there is no burden on the driver. If this judgment is affirmative, the processing proceeds to step 608. If this judgment is negative, the processing proceeds to step 610.

In step 608, the control ECU 30 carries out behavior control of the virtual fellow passenger 50, and the processing ends. In the behavior control of the virtual fellow passenger 50, for example, the control ECU 30 controls the 3D stereoscopic display device 26 and the speaker 24 so as to display an image of the virtual fellow passenger 50 making a proposal expressed by the presentation information based on the results of the preference analysis, and so as to generate a voice based on the conversation information. For example, based on the information collected from the onboard unit 12, in a case in which the current state deviates from the preferred state of the vehicle occupant, the ECU 30 effects control so as to display an image of the virtual fellow passenger 50 proposing a preferred state, and so as to generate a voice corresponding to the contents of the proposal.

Otherwise, in step 610, by outputting a voice from the speaker 24 indicating the presentation information, the control ECU 30 informs the vehicle occupant of the presentation information without displaying the virtual fellow passenger 50, and the processing ends.

Due to the processing being carried out at the respective sections of the in-vehicle system 10 in this way, the states of the vehicle and the vehicle occupant are understood, and the virtual fellow passenger 50 may give various proposals to the vehicle occupant based thereon.

In the above-described embodiment the virtual fellow passenger 50 is not displayed when there is a driving burden in order to ensure safety. However, the disclosure is not limited to this. For example the virtual fellow passenger 50 may be displayed and communication may be made possible regardless of the driving burden, as in the case of a conversation with an ordinary fellow passenger, in a vehicle that is not equipped with an automatic driving function. Alternatively, when there is a driving burden, only the display of the virtual fellow passenger 50 may be terminated and conversation with the virtual fellow passenger 50 may be still enabled.

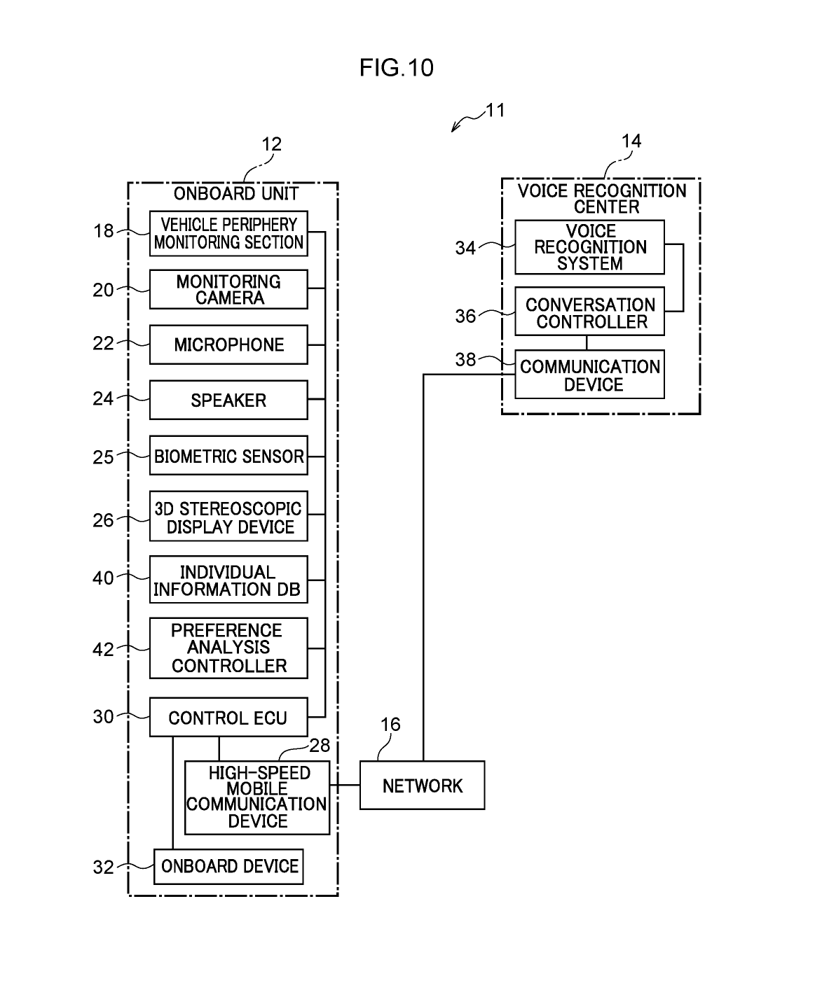

Further, the above-described embodiment describes a configuration in which the processing is carried out at respective sections of the onboard unit 12, the voice recognition center 14 and the information DB center 15, but the disclosure is not limited to this. For example, as illustrated in FIG. 10, there may be an in-vehicle system 11 with a configuration in which the information DB center 15 is installed in the onboard unit 12. Alternatively, an in-vehicle system 11 may be configured such that, not only the information DB center 15, but also the voice recognition center 14 is installed in the onboard unit 12, and processing is possible within the onboard unit 12. In a case in which the information DB center 15 is installed in the onboard unit 12, the frequency of communication using the network 16 is lower than in the above-described embodiment and the communication cost is reduced, but the data amount that is stored in the onboard unit 12 increases. Further, in a case in which all of these external centers are installed in the onboard unit 12, there is no need for communication, and communication time and communication costs may be reduced, but the data amount that is stored in the onboard unit 12 becomes even greater.

Further, a device that generates ultrasonic waves may be further provided at the onboard unit 12 of the in-vehicle system 10 according to the embodiment, and tactile sensations such as warmth of the skin and the like may also be imparted to the vehicle occupant.

Further, although the above embodiment describes an example in which the virtual fellow passenger 50 is displayed by the 3D stereoscopic display device 26, the disclosure is not limited to this. For example, a head-mounted display (HMD) or a goggle-type display device may be used to display the virtual fellow passenger 50. In this case, the virtual fellow passenger 50 may be displayed by using various types of known techniques such as Virtual Reality (VR), Augmented Reality (AR), Mixed Reality (MR), or the like.

The processing carried out at the respective sections of the in-vehicle system 10 in the above-described embodiment may be software processing carried out as a result of the execution of programs, or may be processing carried out by hardware. Alternatively, the processing may be performed by a combination of software and hardware. Further, in the case of processing by software, the programs may be stored on any of various types of storage media and may be distributed.

The present disclosure is not limited to the above, and, other than the above, may of course be implemented by being modified in various ways within a scope that does not depart from the gist thereof.

What is claimed is:

1. An in-vehicle system comprising:
a display section that is configured to stereoscopically display, within a vehicle cabin, a virtual fellow passenger for conversing with a vehicle occupant;
a voice detector that detects a voice of the vehicle occupant;
a voice recognition section that is configured to recognize the voice detected by the voice detector, and generates conversation information for conversing with the vehicle occupant;
a voice generator that generates a voice based on the conversation information; and
a controller that is configured to control the display section and the voice generator based on results of voice recognition of the voice recognition section so as to display an image of the virtual fellow passenger operating an onboard device in accordance with instructions of the vehicle occupant, and so as to generate a voice based on the conversation information, and configured to control the onboard device in accordance with the instruction.

2. The in-vehicle system of claim 1, further comprising a burden detecting section that is configured to detect a driving burden of a driver,
wherein the controller is configured to control the display section such that, in a case in which it is detected by the burden detecting section that there is no driving burden, the virtual fellow passenger is displayed, and, in a case in which it is detected by the burden detecting section that there is the driving burden, the virtual fellow passenger is not displayed.

3. An in-vehicle system comprising:
a display section that is configured to stereoscopically display, within a vehicle cabin, a virtual fellow passenger for conversing with a vehicle occupant;
a voice detector that detects a voice of the vehicle occupant;
a voice recognition section that is configured to recognize the voice detected by the voice detector, and generates conversation information for conversing with the vehicle occupant;
a voice generator that generates a voice based on the conversation information;
a storage section that is configured to store preference information relating to preferences of the vehicle occupant;
a preference analyzing section that is configured to perform analysis of preferences of the vehicle occupant based on the preference information stored in the storage section; and
a controller that is configured to control the display section and the voice generator so as to display an image of the virtual fellow passenger making a proposal based on results of analysis of the preference analyzing section, and so as to generate a voice based on the conversation information that corresponds to the results of analysis.

4. The in-vehicle system of claim 3, further comprising a burden detecting section that is configured to detect a driving burden of a driver,
wherein the controller is configured to control the display section such that, in a case in which it is detected by the burden detecting section that there is no driving burden, the virtual fellow passenger is displayed, and, in a case in which it is detected by the burden detecting section that there is the driving burden, the virtual fellow passenger is not displayed.

5. An in-vehicle system control method comprising:
stereoscopically displaying, within a vehicle cabin, a virtual fellow passenger for conversing with a vehicle occupant;
detecting a voice of the vehicle occupant;
recognizing the detected voice, and generating conversation information for conversing with the vehicle occupant;
based on results of voice recognition, displaying an image of the virtual fellow passenger operating an onboard device in accordance with instructions of the vehicle occupant, and generating a voice based on the conversation information; and
controlling the onboard device in accordance with the instruction.

6. An in-vehicle system control method comprising:
stereoscopically displaying, within a vehicle cabin, a virtual fellow passenger for conversing with a vehicle occupant;
detecting a voice of the vehicle occupant;
recognizing the detected voice, and generating conversation information for conversing with the vehicle occupant;
performing preference analysis of the vehicle occupant based on preference information of the vehicle occupant that is stored in a storage section; and
displaying an image of the virtual fellow passenger making a proposal based on results of the preference analysis, and generating a voice based on the conversation information that corresponds to the results of preference analysis.

7. A non-transitory storage medium storing a program that causes a computer to perform an in-vehicle system control processing, the processing comprising:
stereoscopically displaying, within a vehicle cabin, a virtual fellow passenger for conversing with a vehicle occupant;
detecting a voice of the vehicle occupant;
recognizing the detected voice, and generating conversation information for conversing with the vehicle occupant;
based on results of voice recognition, displaying an image of the virtual fellow passenger operating an onboard device in accordance with instructions of the vehicle occupant, and generating a voice based on the conversation information; and
controlling the onboard device in accordance with the instruction.

8. A non-transitory storage medium storing a program that causes a computer to perform an in-vehicle system control processing, the processing comprising:
stereoscopically displaying, within a vehicle cabin, a virtual fellow passenger for conversing with a vehicle occupant;
detecting a voice of the vehicle occupant;
recognizing the detected voice, and generating conversation information for conversing with the vehicle occupant;
performing preference analysis of the vehicle occupant based on preference information of the vehicle occupant that is stored in a storage section; and
displaying an image of the virtual fellow passenger making a proposal based on results of the preference analysis, and generating a voice based on the conversation information that corresponds to the results of preference analysis.
